(19) United States
(12) Patent Application Publication
(10) Pub. No.: US 2017/0102719 A1
(43) Pub. Date: Apr. 13, 2017

(54) EXCHANGEABLE ORIFICE BINARY VALVE

(71) Applicant: General Electric Company, Schenectady, NY (US)

(72) Inventors: Edward John Halusic, III, Houston, TX (US); Michael Feinstein, Houston, TX (US); Alan James Kemmerer, Joppa, MD (US)

(21) Appl. No.: 14/878,686

(22) Filed: Oct. 8, 2015

(51) Int. Cl. G05D 7/06; F02C 7/232; F02C 9/26; F02C 7/22; F16K 31/06; G01F 1/42

(52) U.S. Cl. CPC G05D 7/0652; F16K 31/06; G01F 1/42; F02C 9/263; F02C 7/222; F02C 7/232; F05D 2220/32; F05D 2260/60

(57) ABSTRACT

A system includes a fluid valve metering system which regulates a flow of a fluid within a gas turbine engine. The fluid valve metering system includes an inlet manifold, an outlet manifold in fluid communication with the inlet manifold, and multiple fluid conduits extending between the inlet manifold and the outlet manifold. Each respective fluid conduit of the multiple fluid conduits includes a respective fluid conduit valve of the multiple fluid conduit valves. Each fluid conduit valve regulates fluid the flow of the fluid through the respective fluid conduit. The fluid valve metering system also includes multiple differently sized orifices and a controller. The controller is coupled to the fluid valve metering system and programmed to monitor a usage of each orifice of multiple differently sized orifices, of each fluid conduit valve of multiple fluid conduit valves, or a combination thereof.

### BACKGROUND

The subject matter disclosed herein relates to gas turbine engines, such as a system and method for regulating fluid flow within a gas turbine engine.

Gas turbine systems generally include a compressor, a combustor, and a turbine. The combustor combusts a mixture of compressed air and fuel to produce hot combustion gases directed to the turbine to produce work, such as to drive an electrical generator. The compressor compresses air from an air intake, and subsequently directs the compressed air to the combustor. The flow of fuel must be carefully monitored to produce the required output while remaining compliant with emissions regulations, output demands, and so forth. Fuel controllers need to provide precise adjustments in the flow of fuel to remain compliant.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In a first embodiment, a system includes a fluid valve metering system which regulates a flow of a fluid within a gas turbine engine. The fluid valve metering system includes an inlet manifold, an outlet manifold in fluid communication with the inlet manifold, and multiple fluid conduits extending between the inlet manifold and the outlet manifold. Each respective fluid conduit of the multiple fluid conduits includes a respective fluid conduit valve of the multiple fluid conduit valves. Each fluid conduit valve regulates the flow of the fluid through the respective fluid conduit. The fluid valve metering system also includes multiple differently sized orifices and a controller. The controller is coupled to the fluid valve metering system and programmed to monitor a usage of each orifice of the multiple differently sized orifices, of each fluid conduit valve of the multiple fluid conduit valves, or a combination thereof.

In a second embodiment, a system includes a fluid valve metering system which regulates a flow of a fluid within a gas turbine engine. The fluid valve metering system includes an inlet manifold, an outlet manifold in fluid communication with the inlet manifold, and multiple fluid conduits extending between the inlet manifold and the outlet manifold. Each respective fluid conduit of the multiple fluid conduits includes a respective fluid conduit valve of multiple fluid conduit valves which regulates fluid flow of the fluid through the respective fluid conduit. The fluid valve metering system interchangeably adjusts which orifice of the multiple differently sized orifices is used with the respective fluid conduit valve of the multiple fluid conduit valves.

In a third embodiment, a method includes utilizing a controller of a fuel metering valve system. The fuel metering valve system includes an inlet manifold, an outlet manifold in fluid communication with the inlet manifold, and multiple fluid conduits extending between the inlet manifold and the outlet manifold. Each respective fluid conduit of the multiple fluid conduits includes a respective fluid conduit valve of multiple fluid conduit valves which regulate the flow of the fluid through the respective fluid conduit. The fuel metering valve system also includes multiple differently sized orifices. The fuel metering valve system may monitor a usage of each orifice of the multiple differently sized orifices, of each fluid conduit valve of the multiple fluid conduit valves, or a combination thereof. The fuel metering valve system may also interchangeably adjust which orifice of the multiple differently sized orifices is used with the respective fluid conduit valve of the multiple fluid conduit valves based on the monitored usage.

### BRIEF DESCRIPTION OF THE DRAWINGS

These and other features, aspects, and advantages of the present subject matter will become better understood when the following detailed description is read with reference to the accompanying drawings in which like characters represent like parts throughout the drawings, wherein:

FIG. 1 is a block diagram of an embodiment of a turbine system having a compressor or turbine that includes a fluid valve metering system;

FIG. 2 illustrates a fluid valve metering system where a fluid is metered with a plurality of orifice plates;

FIG. 3 illustrates the fluid valve metering system of FIG. 1, where a fluid is metered without orifice plates;

FIG. 4 illustrates an embodiment of the fluid valve metering system of FIG. 1, including a cylindrical tube arrangement;

FIG. 5 illustrates an embodiment of a gear assembly that may be utilized with the fluid valve metering system of FIG. 1;

FIG. 6 illustrates a method of adjusting flow of the fluid valves used in the fluid valve metering system of FIG. 1; and

FIG. 7 illustrates a method of controlling the fuel flow of the fluid valve metering system of FIG. 1.

### DETAILED DESCRIPTION

One or more specific embodiments of the present subject matter will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present subject matter, the articles “a,” “an,” “the,” and “said” are intended to mean that there are one or more of the elements. The terms “comprising,” “including,” and “having” are intended to be inclusive and mean that there may be additional elements other than the listed elements.

A system and a method for regulating a flow of a fluid (e.g., fuel) within a gas turbine engine through a fluid valve metering system (e.g., fuel metering valve system) is described in detail below. Gas turbine engines generally use a fuel metering valve on each incoming fuel line. The fuel flow controller actuates a valve component to control the volume of the flow of fuel through the fuel line. Some valves may experience more frequent actuation, thus resulting in faster wear on the valves that are used more frequently. As such, an improved fluid valve metering system may reduce mechanical wear, increase time between maintenance, decrease costs associated therewith, and increase lifespan of components of the fluid valve metering system. For example, the improvement fluid valve metering system may increase the lifespan of the components (e.g., fluid conduit valves, orifice plates) of the fluid valve metering system by 2, 3, 4, 5, 6, or more times. The embodiments of the fluid valve metering system as described herein include a plurality of fluid conduits extending between an inlet manifold and an outlet manifold. The inlet manifold and the outlet manifold are fluidly coupled to one another. Each of the plurality of fluid conduits comprises a respective fluid conduit valve configured to regulate a fluid (e.g., fuel) flow through the respective fluid conduit. The fluid valve metering system may interchangeably adjust which orifice of the plurality of differently sized orifices is used with each respective fuel conduit valve. Selectively adjusting which orifice is used with each respective fuel conduit valve enables the life of the fuel conduit valve to be extended by increasing the amount of time that can pass between required maintenance. In some embodiments, interchanging the orifice in conjunction with the fuel conduit valves may be accomplished by utilizing a cylindrical tube arrangement. For example, a first cylindrical tube may be concentrically disposed within a second cylindrical tube. In this arrangement, the plurality of fluid conduits may be arranged to extend between the first cylindrical tube and the second cylindrical tube. One of the cylindrical tubes may include the plurality of differently sized orifices, and the cylindrical tubes may move relative to one another. One or more actuators may be configured to move (e.g., rotate, interchangeably adjust) the first cylindrical tube relative to the second cylindrical tube, or vice versa. This rotation enables selective alignment of the orifice relative to a respective fluid conduit to meet the required flow requirements. In alternate embodiments, interchanging the orifice in conjunction with the fuel conduit may be accomplished utilizing a bank of valves. The orifices may include different sizes (e.g., to meter fluid according to the desired flow rates). For example, smaller orifice plates and their corresponding valves are actuated more frequently than the larger orifice plates due to greater precision of fluid flow that can be accomplished with smaller orifice plates. As such, the smaller orifice plate may require more frequent service and/or replacement than larger orifice plates that are not used as frequently. Accordingly, it may be beneficial to shift between different sizes orifices to extend the life of the frequently used orifice plates and solenoid valves in the illustrated embodiments. Shifting between the different size orifices may be accomplished by selectively changing valves, selectively changing orifice plates, selectively changing the diameter of the orifice when variable-orifices are used, or any combination thereof. In some embodiments, a controller may be programmed to modulate an opening and closing of at least one orifice plate line valve of a plurality of orifice plate line valves. Opening and closing of the orifice plate line valve may regulate the flow of the fluid (e.g., fuel) through the fluid valve metering system.

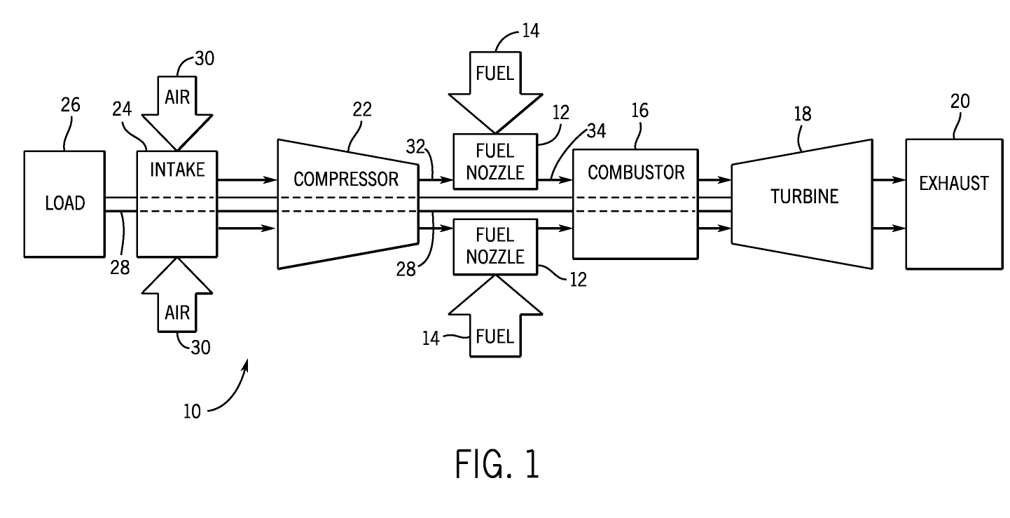

Turning now to the drawings and referring first to FIG. 1, a block diagram of an embodiment of a gas turbine system 10 is illustrated. The diagram includes fuel nozzle 12, fuel 14, and combustor 16. As depicted, fuel 14 (e.g., a liquid fuel and/or gas fuel, such as natural gas) is routed to the turbine system 10 through fuel nozzle 12 into combustor 16. The combustor 16 ignites and combusts the air-fuel mixture 34, and then passes hot pressurized exhaust gas 36 into a turbine 18. The exhaust gas 36 passes through turbine blades of a turbine rotor in the turbine 18, thereby driving the turbine 18 to rotate. The coupling between blades in turbine 18 and shaft 28 will cause the rotation of shaft 28, which is also coupled to several components (e.g., compressor 22, load 26) throughout the turbine system 10. Eventually, the exhaust gases 36 of the combustion process may exit the turbine system 10 via exhaust outlet 20.

In an embodiment of turbine system 10, compressor vanes or blades are included as components of compressor 22. Blades within compressor 22 may be coupled to shaft 28, and will rotate as shaft 28 is driven to rotate by turbine 18. Compressor 22 may intake air 30 to turbine system 10 via an air intake 24. Further, shaft 28 may be coupled to load 26, which may be powered via rotation of shaft 28. As appreciated, load 26 may be any suitable device that may generate power via the rotational output of turbine system 10, such as a power generation plant or an external mechanical load. For example, load 26 may include an electrical generator, a propeller of an airplane, and so forth. The air intake 24 draws air 30 into the turbine system 10 via a suitable mechanism, such as a cold air intake, for subsequent mixture of air 30 with fuel 14 via fuel nozzle 12. Air 30 taken in by turbine system 10 may be fed and compressed into pressurized air 32 by rotating blades within compressor 22. The pressurized air 32 may then be fed into one or more fuel nozzles 12. Fuel nozzles 12 may then mix the pressurized air 32 and fuel 14, to produce a suitable air-fuel mixture 34 for combustion, e.g., a combustion that causes the fuel 14 to more completely burn, so as not to waste fuel 14 or cause excess emissions in the exhaust gases 36. Again, the turbine 18 is driven by the exhaust gases 36, and each stage of the turbine 18 may include the fluid valve metering system 40 described in detail below. As described in detail below, the fluid valve metering system 40 may be utilized to shift between different sizes orifices to extend the life of the frequently used orifice plates and solenoid valves in the illustrated embodiments. Shifting between the different sized orifices may be accomplished by selectively changing valves, selectively changing orifice plates, selectively changing the diameter of the orifice when variable-orifices are used, or any combination thereof. Shifting between the different size orifices may reduce the wear and associated costs and downtime associated with regular (e.g., near constant) use.

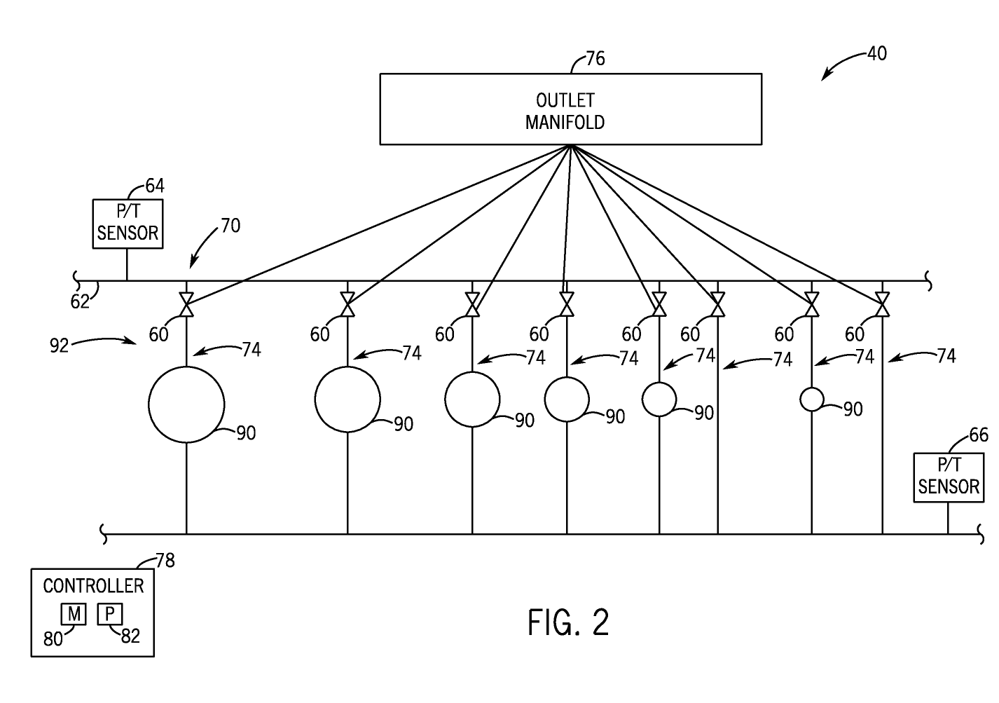

FIG. 2 illustrates the fluid valve metering system 40 of FIG. 1, where a fluid (e.g., fuel 14) is metered with a plurality of orifice plates 90. Though the fluid conduit valves 60 and the orifice plates 90 are shown in parallel, any configuration of the fluid conduit valves 60 and the orifice plates 90 may be used. In embodiments where the fluid conduit valves 60 and the orifice plates 90 are arranged in a parallel configuration, as shown, the fluid flow can be increased as more fluid conduit valves 60 are opened.

The plurality of orifices 90 may include different sizes (e.g., to meter fluid according to the desired flow rates). For example, the smaller the orifice plate 90 and its corresponding valve 60 are actuated more frequently than the larger orifice plates 90 due to the precision of fluid flow the smaller orifice plate 90 offers. As such, the smaller orifice plate 90 may require more frequent service and/or replacement than larger orifice plates 90 that are not used as frequently. Accordingly, it may be beneficial to shift between different sized orifices to extend the life of the frequently used orifice plates 90 and solenoid valves 60. Shifting between different sized orifices may increase the lifespan of the components (e.g., fluid conduit valves, orifice plates) of the fluid valve metering system by 2, 3, 4, 5, 6, or more times.

Shifting between the different sized orifices may be accomplished by selectively changing valves 60, selectively changing orifice plates 90, selectively changing the diameter of the orifice when variable-orifices are used, or any combination thereof. In some embodiments, the orifice plates 90 are sized according to the desired flow configuration. For example, the smallest orifice plate 90 may be sized for the smallest anticipated flow of fluid while the next orifice plate (e.g., adjacent orifice plate), may be sized to double that flow or to increase the flow by any predetermined percentage.

In some embodiments, the controller 78 may be programmed to modulate an opening and closing of at least one orifice plate line valve 92 of a plurality of orifice plate line valves 92. Opening and closing of the orifice plate line valve 92 may regulate the flow of the fluid (e.g., fuel 14) through the fluid valve metering system 40. For example, the controller 78 may modulate the opening and closing of the orifice plate line valves 92 via pulse-width modulation or any other suitable means to accomplish the opening and closing of the orifice plate line valves 92. The modulation may simulate use of a differently sized orifice (e.g., by increase or decreasing flow by rapid opening and closing of the valve). The modulation may be controlled based in part on a monitored usage of the system 10, a use input, or any other suitable means. It should be appreciated that the fluid valve metering system 40 may operate with or without pulse-width modulation.

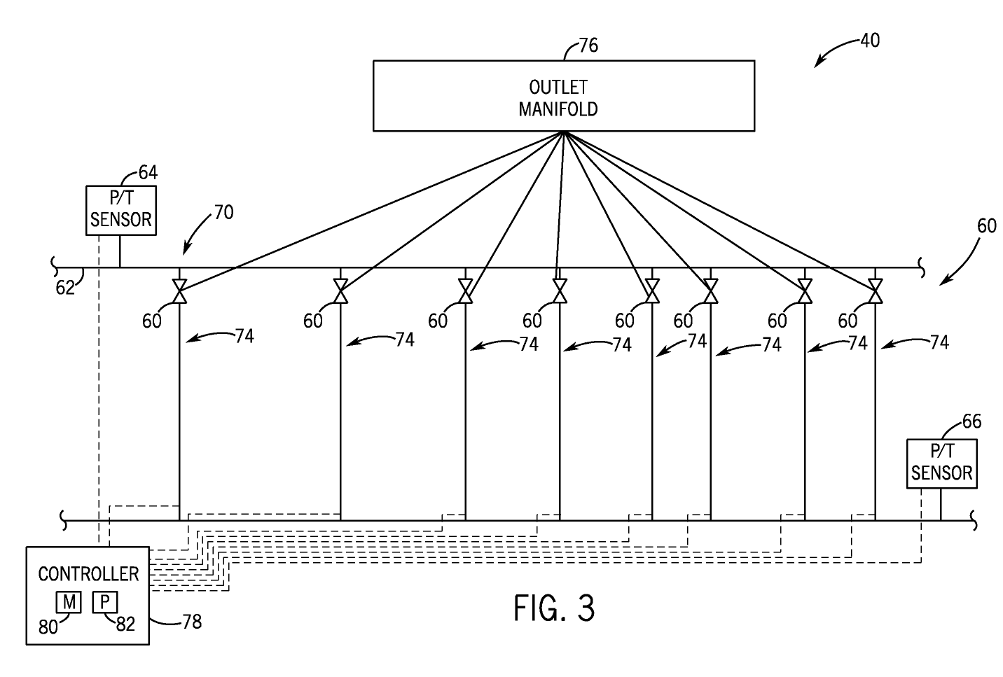

FIG. 3 illustrates a fluid valve metering system 40 where a fluid (e.g., fuel 14) is metered without orifice plates. A plurality of fluid conduit valves 60 may be positioned about a fluid conduit 62 (e.g., an incoming fluid line). An upstream sensor 64 (e.g., pressure, temperature) may be positioned upstream of the fluid metering valve system 40. A downstream sensor 66 (e.g., pressure, temperature) may be positioned downstream of the fluid metering valve system 40. As will be appreciated, the sensors 64, 66 may be in communication with a controller 78 or other type of control device coupled to the gas turbine system 10. Other types of sensors may be used herein so as to monitor different types of operational parameters and the like herein.

The fluid metering valve system 40 may include an inlet manifold 70. The inlet manifold 70 may be in communication with a fluid conduit 62. The inlet manifold 70 may be in communication with a number of fluid conduit valve lines 74. An outlet manifold 76 may be in fluid communication with the fluid conduit 62 and inlet manifold 70. The fluid metering valve system 40 also may include a fluid flow controller 78. The fluid flow controller 78 may be coupled to the fluid valve metering system 40 and programmed to monitor usage of each fluid conduit valve 60 (e.g., solenoid valves) of the plurality of fluid conduit valves 60. As described in further detail below, shifting between the different sized orifices may be accomplished by selectively changing valves, selectively changing orifice plates, selectively changing the diameter of the orifice when variable-orifices are used, or any combination thereof. In some embodiments, the fluid flow controller 78 may be programmed to modulate an opening and closing of at least one orifice plate line valve of a plurality of orifice plate line valves. Opening and closing of the orifice plate line valve may regulate the flow of the fluid (e.g., fuel) through the fluid valve metering system 40. The opening and closing (e.g., modulation) of the at least one orifice plate line valve may be controlled based in part on a monitored usage of the system 10, a use input, or any other suitable means. It should be appreciated that the fluid valve metering system 40 may operate with or without pulse width modulation.

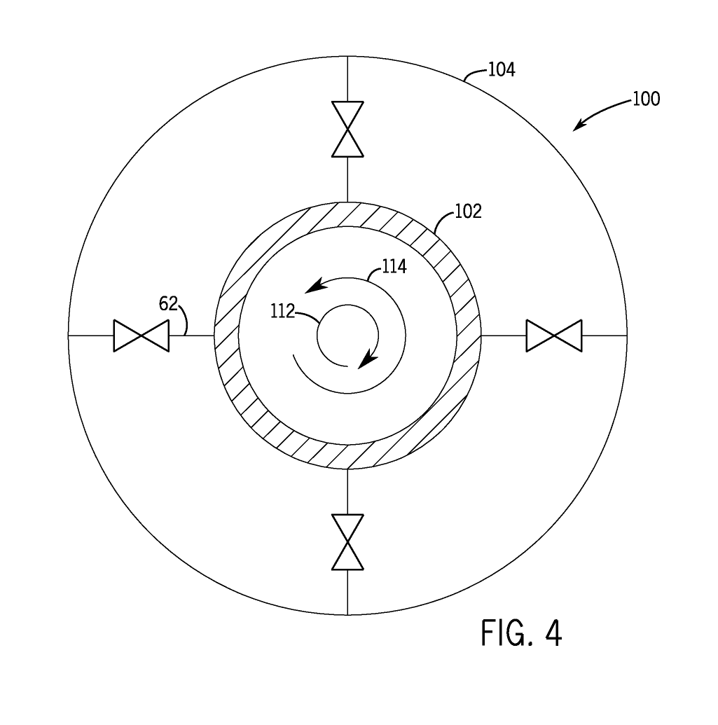

The fluid flow controller 78 may monitor operating conditions such as the number of times each valve 60 is used, the length of time each valve 60 has been in operation, and so forth. By monitoring these operating conditions, the fluid flow controller 78 may determine which valves 60 should be adjusted earlier than other valves 60 exhibiting less wear. In certain embodiments, the controller 78 may include a memory 80 to store instructions and a processor 82 configured to execute the instructions. The memory 80, in the embodiment, includes a computer readable medium, such as, without limitation, a hard disk drive, a solid state drive, diskette, flash drive, a compact disc, a digital video disc, random access memory (RAM and/or flash RAM), and/or any suitable storage device that enables the processor 82 to store, retrieve, and/or execute instructions (e.g., software or firmware) and/or data (e.g., thresholds, ranges, etc.). The memory 80 may include one or more local and/or remote storage devices. The processor 82 may include multiple microprocessors, one or more “general-purpose” microprocessors, one or more special-purpose microprocessors, and/or one or more application specific integrated circuits (ASICS), system-on-chip (SoC) device, or some other processor configuration. For example, the processor 82 may include one or more reduced instruction set (RISC) processors or complex instruction set (CISC) processors. The controller 78 may include an operator interface configured to receive operator input, such as a desired flow rate, a desired composition of the fluid, or any combination thereof. It will be appreciated that the fluid conduit valves (e.g., solenoid valves) are configured to have adjustable flow rates. Alternate embodiments of the fluid valve metering system 40 may be further understood with respect to FIG. 4.

FIG. 4 illustrates an embodiment of the fluid valve metering system of FIG. 1, including a cylindrical tube arrangement 100. As described above, the fluid valve metering system 40 may adjust (e.g., selectively interchange) a specific orifice plate 90 that is utilized within the plurality of orifice plate line valves 92 based on a monitored usage (e.g., by the controller 78) or a user input. Interchanging the orifice plate 90 in conjunction with the orifice plate line valves 92 may be accomplished by utilizing the cylindrical tube arrangement 100. For example, the fluid valve metering system 40 may include a first cylindrical tube 102 concentrically disposed within a second cylindrical tube 104. In this arrangement, the fluid flow may flow from outside of the cylindrical tube arrangement 100 towards the center of the arrangement. The plurality of fluid conduits 62 may be arranged to extend between the first cylindrical tube 102 and the second cylindrical tube 104. One of the cylindrical tubes may include the plurality of differently sized orifices, and the cylindrical tubes may move relative to one another. For example, the second cylindrical tube 104 may include the plurality of differently sized orifices.

In some embodiments, the fluid valve metering system 40 may work by rotating the first cylindrical tube 102 relative to the second cylindrical tube 104. The first cylindrical tube 102 may rotate clockwise 112, counterclockwise 114, or may alternate between rotating clockwise 112 and counterclockwise 114 to move relative to the second cylindrical tube 104. In alternate embodiments, the fluid valve metering system 40 may work by rotating the second cylindrical tube 104 relative to the first cylindrical tube 102. The second cylindrical tube 104 may rotate clockwise, counterclockwise, or may alternate between rotating clockwise 112 and counterclockwise 114 to move relative to the first cylindrical tube 102. It should be appreciated that the rotation of either the first cylindrical tube 102, the second cylindrical tube 104, or both may be manually achieved or automated via the controller 78. As described in further detail below, it should be appreciated that the illustrated embodiment of the fluid valve metering system 40 may operate with or without pulse width modulation.

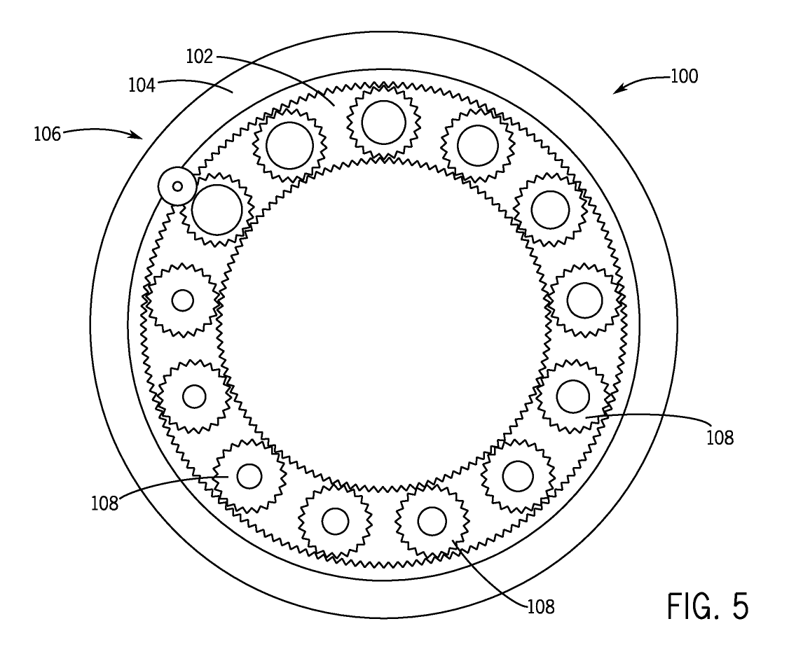

FIG. 5 illustrates an embodiment of a gear assembly utilized with the fluid valve metering system 40 of FIG. 1. One or more actuators 106 may be configured to move (e.g., rotate, interchangeably adjust) the first cylindrical tube 102 relative to the second cylindrical tube 104, or vice versa. This rotation enables selective alignment of the orifice relative to a respective fluid conduit 62 to meet the required flow requirements. Though the cylindrical tube arrangement 100 is described in a tube or cylinder shape, it will be appreciated by one of ordinary skill in the art that the tube may be any suitable polygonal shape (e.g., elliptical, ovular, square, and so forth).

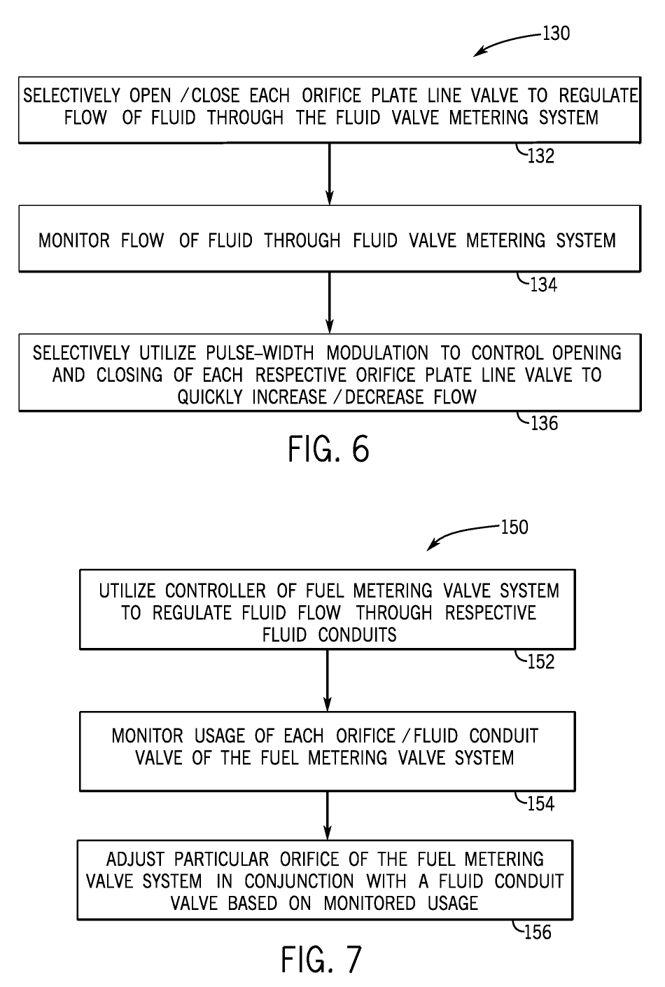

The actuator 106 may include a fluid drive (e.g., pneumatic or hydraulic), an electric drive, or any other suitable drive means to rotate the cylindrical tubes 102, 104. As will be appreciated, the actuator 106 may be actuated by the controller 78 to change (e.g., adjust, select) the orifice to a fluid conduit valve 60 based at least in part on the monitored usage of the fluid valve metering system 40. The cylindrical tube arrangement 100 may include a plurality of gears 108 (e.g., free gears). Each gear 108 is coupled to a respective orifice of the plurality of differently sized orifices. The gears 108 may be translated (e.g., rotated) via the actuator 106. This rotation enables the plurality of differently sized orifices to be aligned with the respective fluid conduit 62. Accordingly, the life of the smaller sized orifice plates 90 and plate line valves 92 may be extended by allowing the smaller sized orifice plate 90 and plate line valves 92 to “rest” between high use (e.g., frequent actuation) cycles of operation. Though the above description describes the rotation by automated means, it should be appreciated this movement may be done manually. For example, an operator or user may loosen fasteners (e.g., bolts) disposed around the cylindrical tubes 102, 104 to release pressure from an associated seal. Then, the operator or user may manually move a lever or actuation device to change the position of the solenoids. Upon selecting a suitable solenoid valve, the operator may then re-tighten the fasteners (e.g., bolts) back down so that the associated seal is formed again and operation of the fluid valve metering system 40 may resume. In the embodiments described herein, visual indicia may be utilized in the cylindrical tube arrangement 100 to help ensure the orifice is aligned with the respective fluid conduit 62. For example, the visual indicia may include tick marks, lights, or other suitable markings to help identify proper alignment of the orifice with the fluid conduit 62. It may be appreciated that the alignment of the orifice with the fluid conduit 62 may be done manually or electronically, as described further with respect to FIGS. 6-7.

FIGS. 6 and 7 illustrate methods of controlling and/or adjusting various components of the fluid valve metering system 40. The method 130 described in FIG. 6 illustrates a method of adjusting flow of the fluid valves used in the fluid valve metering system 40 of FIG. 1. As described by the method 130, the fluid flow may be adjusted by selectively opening and/or closing each orifice plate line valve to regulate flow of fluid through the valve metering system (block 132). By selectively opening and/or closing the orifice plate line valve fast enough, the fluid flow can be adjusted by quick pulse opening and/or closing. The method 130 includes monitoring the flow of the fluid through the fluid valve metering system (block 134). Based upon the monitored flow, the controller may be configured to selectively adjust the flow of fluid. This may be accomplished by selectively utilizing pulse-width modulation to control the opening and closing of each respective orifice line plate valve to quickly increase or decrease the flow (block 136). As described above, the increase or decrease of the flow of the fluid is based at least in part on the monitored flow. By utilizing pulse-width modulation to quickly increase or decrease the flow, different sized orifices can be simulated.

FIG. 7 illustrates a method 150 of controlling the fuel flow of the fluid valve metering system 40 of FIG. 1. The method 150 may include utilizing a controller of the fuel metering valve system 40 to regulate fluid flow through various fluid conduits (block 152). The controller may utilize feedback from sensors disposed within the valve metering system 40 to monitor usage. In particular, the controller may monitor usage of each orifice and/or fluid conduit valve of the fuel metering valve system (block 154). Based at least in part on the monitored usage, the controller may selectively adjust a particular orifice of the fuel metering valve system in conjunction with a fluid conduit valve (block 156). For example, the controller may selectively adjust a particular orifice of the fuel metering valve system by a technique such as pulse-width modulation. The controller may interchangeably adjust the particular orifice by rotating or otherwise moving the orifice plate of the different sized orifice plates is used with a respective orifice plate line valve. The adjustment may be based in part on the monitored usage of the valve metering system.

Technical effects of the disclosed embodiments include regulating a flow of a fluid within a gas turbine engine through a fluid valve metering system. Each of the plurality of fluid conduits comprises a respective fluid conduit valve configured to regulate a fluid (e.g., fuel) flow through the respective fluid conduit. The fluid valve metering system may interchangeably adjust which orifice of the plurality of differently sized orifices is used with each respective fuel conduit valve. Selectively adjusting which orifice is used with each respective fuel conduit valve enables the life of the fuel conduit valve to be extended by increasing the amount of time that can pass between required maintenance.

This written description uses examples to disclose the subject matter, including the best mode, and also to enable any person skilled in the art to practice the subject matter, including making and using any devices or systems and performing any incorporated methods. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a fluid valve metering system configured to regulate a flow of a fluid within a gas turbine engine, comprising:
an inlet manifold;
an outlet manifold in fluid communication with the inlet manifold;
a plurality of fluid conduits extending between the inlet manifold and the outlet manifold, wherein each respective fluid conduit of the plurality of fluid conduits comprises a respective fluid conduit valve of a plurality of fluid conduit valves configured to regulate the flow of the fluid through the respective fluid conduit; and
a plurality of differently sized orifices, and
a controller coupled to the fluid valve metering system and programmed to monitor a usage of each orifice of the plurality of differently sized orifices, of each fluid conduit valve of the plurality of fluid conduit valves, or a combination thereof.

2. The system of claim 1, wherein the controller is programmed to open and close each orifice plate line valve of the plurality of orifice plate line valves to regulate the flow of the fluid through the fluid valve metering system, and the controller is configured to utilize pulse-width modulation to control the opening and closing of each respective orifice plate line valve of the plurality of orifice plate line based on the monitored usage.

3. The system of claim 2, wherein the controller is programmed to modulate an opening and closing of at least one orifice plate line valve of the plurality of orifice plate line valves to simulate a use of an orifice of a different size than a respective orifice plate of the plurality of differently sized orifice plates coupled to the at least one orifice plate line valve.

4. The system of claim 1, wherein the fluid valve metering system is configured to interchangeably adjust which orifice plate of the plurality of differently sized orifice plates is used with a respective orifice plate line valve of the plurality of orifice plate line valves based on the monitored usage.

5. The system of claim 4, wherein the fluid valve metering system comprises at least one actuator configured to interchangeably adjust which orifice of the differently sized orifices is used with the respective fluid valve of the plurality of fluid conduit valves.

6. The system of claim 5, wherein the controller is coupled to the at least one actuator and is programmed to control the actuator to interchangeably adjust which orifice of the differently sized orifices is used with the respective fluid valve of the plurality of fluid conduit valves based on the monitored usage.

7. The system of claim 5, wherein the at least one actuator comprises a fluid drive or an electric drive.

8. The system of claim 4, wherein the fluid valve metering system comprises a first cylindrical tube concentrically arranged with a second cylindrical tube, wherein the plurality of fluid conduits extend between the first and second cylindrical tubes, the second cylindrical tube comprises the plurality of different sized orifices, and the at least one actuator is configured to move either the first or second cylindrical tube to align a respective orifice of the plurality of different sized orifices with a respective fluid conduit of the plurality of fluid conduits.

9. The system of claim 4, wherein the fluid valve metering system comprises a plurality of free gears, each free gear of the plurality of free gears comprising a respective orifice of the plurality of different sized orifices, and the at least one actuator is configured to rotate the plurality of gears to align a respective orifice of the plurality of different sized orifices with a respective fluid conduit of the plurality of fluid conduits.

10. The system of claim 4, wherein the fluid valve metering system comprises a plate having the plurality of different sized orifices, and the at least one actuator is configured to rotate the plate to align a respective orifice of the plurality of different sized orifices with a respective fluid conduit of the plurality of fluid conduits.

11. The system of claim 1, wherein the plurality of fluid conduit valves comprises a plurality of solenoid valves.

12. The system of claim 11, wherein each solenoid valve of the plurality of solenoid valves is configured to have an adjustable flow rate.

13. The system of claim 1, wherein the plurality of different sized orifices comprises a plurality of adjustable valves.

14. The system of claim 1, comprising the gas turbine engine having the fluid valve metering system.

15. A system, comprising:
a fluid valve metering system configured to regulate a flow of a fluid within a gas turbine engine, comprising:
an inlet manifold;
an outlet manifold in fluid communication with the inlet manifold;
a plurality of fluid conduits extending between the inlet manifold and the outlet manifold, wherein each respective fluid conduit of the plurality of fluid conduits comprises a respective fluid conduit valve of a plurality of fluid conduit valves configured to regulate flow of the fluid through the respective fluid conduit; and
wherein the fluid valve metering system is configured to interchangeably adjust which orifice of the plurality of differently sized orifices is used with the respective fluid conduit valve of the plurality of fluid conduit valves.

16. The system of claim 15, the fluid valve metering system comprises at least one actuator configured to interchangeably adjust which orifice of the differently sized orifices is used with the respective fluid valve of the plurality of fluid conduit valves.

17. The system of claim 16, comprising a controller coupled to the at least one actuator that is programmed to control the actuator to interchangeably adjust which orifice of the differently sized orifices is used with the respective fluid valve of the plurality of fluid conduit valves.

18. The system of claim 16, wherein the fluid valve metering system comprises a first cylindrical tube concentrically arranged with a second cylindrical tube, wherein the plurality of fluid conduits extend between the first and second cylindrical tubes, the second cylindrical tube comprises the plurality of different sized orifices, and the at least one actuator is configured to move either the first or second cylindrical tube to align a respective orifice of the plurality of different sized orifices with a respective fluid conduit of the plurality of fluid conduits.

19. The system of claim 16, wherein the fluid valve metering system comprises a plate having the plurality of different sized orifices, and the at least one actuator is configured to rotate the plate to align a respective orifice of the plurality of different sized orifices with a respective fluid conduit of the plurality of fluid conduits.

20. A method, comprising:
utilizing a controller of a fuel metering valve system, the fuel metering valve system comprising an inlet manifold, an outlet manifold in fluid communication with the inlet manifold, a plurality of fluid conduits extending between the inlet manifold and the outlet manifold, each respective fluid conduit of the plurality of fluid conduits comprises a respective fluid conduit valve of a plurality of fluid conduit valves configured to regulate the flow of the fluid through the respective fluid conduit, and a plurality of differently sized orifices, to performs the steps of:
monitoring a usage of each orifice of the plurality of differently sized orifices, of each fluid conduit valve of the plurality of fluid conduit valves, or a combination thereof; and
interchangeably adjusting which orifice of the plurality of differently sized orifices is used with the respective fluid conduit valve of the plurality of fluid conduit valves based on the monitored usage.
